(19) United States
(12) Patent Application Publication
(10) Pub. No.: US 2002/0027558 A1
(43) Pub. Date: Mar. 7, 2002

(54) Data transfer apparatus and method

(76) Inventor: Kinya Osa, Tokyo (JP)

Correspondence Address: FITZPATRICK CELLA HARPER & SCINTO, 30 ROCKEFELLER PLAZA, NEW YORK, NY, 10112, US

(21) Appl. No.: 09/875,855

(22) Filed: Jun. 8, 2001

(30) Foreign Application Priority Data
Jun. 9, 2000 (JP) 174024/2000

(51) Int. Cl. G06F 13/00

(52) U.S. Cl. 345/537

(57) ABSTRACT

In bit plane coding, bit plane(s) to be encoded are selected, and coding is performed only on the selected bit plane(s). At step S701, a maximum value of data is obtained. At step S702, respective bits constructing the maximum value data are examined from a higher-order bit (MSB). At step S703, if the bit is 1, at step S704 the order of the bit from the highest order is specified, thus a highest-order significant bit plane is specified, and the process ends. On the other hand, if it is determined at step S703 that the bit is 0, the next bit constructing the maximum value is examined.

### FIELD OF THE INVENTION

The present invention relates to data transfer apparatus and method for outputting a data group consists of data represented by plural bits to predetermined processing means.

### BACKGROUND OF THE INVENTION

Today, in a general image coding method such as JPEG, pixel value or coefficient values resulted from conversion such as DCT are handled as multi-valued data consists of plural-bit. The multi-valued data is encoded by a coding method such as the Huffman coding.

Regarding a new image coding method such as JPEG2000, standardization of which is progressing for higher coding performance, studies are made on bit plane coding of dividing pixel values or coefficient values into planes for respective bits constructing the multi-valued instead of handling the pixel value or coefficient values as multi-valued data. As a usage of bit plane coding, as shown in FIG. 2, coded data 22 is generated by bit-plane encoding (21) pixel values of original image 20, otherwise, as shown in FIG. 3, coded data 33 is generated by first converting pixel value of original image 30 to coefficient values by transform coding (31) such as DCT or Wavelet transform and then performing bit-plane coding (32) on the coefficient values.

However, the conventional techniques have the following problem. FIG. 4 shows an example of conventional bit-plane coding processing as an explanation of the problem.

In FIG. 4, in a case where an array 40 of 4×4 pixel values or coefficient values is bit-plane encoded, assuming that the number of bits (bit depth) to represent the pixel values or coefficient values is 6, the multi-valued array can be divided into 6 bit planes (41 to 46). Note that the highest-order bit plane 5 (41) may be called an MSB (Most Significant Bit), and the lowest-order bit plane 0 (46), an LSB (Least Significant Bit).

Each bit in binary representation of each pixel value or coefficient value is the value of bit in the same position in each bit plane. For example, among the pixels of the array 40, the binary representation of pixel value 12 is 001100. Thus, in the bit plane 5 (41), the value in the top leftmost bit position is 0; in the bit plane 4 (42), the value in the same position is 0; in the bit plane 3 (43), the value in the same position is 1; in the bit plane 2 (44), the value in the same position is 1; in the bit plane 1 (45), the value in the same position is 0; and in the bit plane 0 (46), the value in the same position is 0.

The bit planes, the bit data are encoded while they are sequentially scanned from the MSB bit plane, in the order as represented by the arrow in FIG. 4. Thus all the 6 bit planes are sequentially encoded, thereby bit plane coding is completed.

The bit plane coding enables high-performance coding, however, when it is practically used, the following problem occurs.

In the example of FIG. 4, if the multi-valued data 40 is encoded, the number of data symbols to be handled is 4×4=16. On the other hand, in the case of bit plane coding, as each bit of bit plane is handled as a data symbol, the number of data symbols is 4×4×6=96, i.e., the number of data symbols increases in correspondence with the bit depth.

In the both coding processings, the total number of bits of the data to be handled is the same. However, since coding processing is performed in data symbol units, if the number of the data symbols is large, the number of coding processings increases, and much time is required for the entire processing.

In the example of FIG. 4, all the bit values constructing the higher-order 2 that are bit planes 5 (41) and 4 (42) are 0, and an actually significant bit (a bit having a bit value 1) is included in the bit plane 3 (43) and the lower-order bit planes. In actual image coding processing, the dynamic range of processed data is often smaller than the bit depth of data storage area, and all the bit values of higher-order bit planes are often 0, as shown in FIG. 4 as a general case. This occurs since bit depth of data storage area is set in correspondence with the maximum value of pixel values or coefficient values, or the bit depth is set in large bit units such as 8-bit units due to memory hardware structure.

### SUMMARY OF THE INVENTION

The present invention has been made in consideration of the above problem, and has its object to reduce time required for bit plane coding by selecting bit plane(s) to be encoded and performing coding only on the selected bit plane(s).

To attain the foregoing object, a data transfer apparatus of the present invention has the following construction. That is, provided is a data transfer apparatus for outputting a data group having data represented by plural bits to predetermined processing means, comprising: detection means for detecting a maximum value in the data group as a transfer object; and specifying means for specifying a non-zero highest-order bit position among bits constructing the maximum value detected by the detection means, wherein a bit in a position higher than the highest-order bit position specified by the specifying means is omitted from processing by the predetermined processing means.

Further, the foregoing object is attained by providing a data transfer apparatus for outputting a data group having data represented by plural bits to predetermined processing means, comprising: calculation means for performing logical OR calculation on all the data group to be transferred; and specifying means for specifying a non-zero highest-order bit position among bits constructing the result of the logical OR calculation by the calculation means, wherein a bit in a position higher than the highest-order bit position specified by the specifying means is omitted from processing by the predetermined processing means.

Further, the foregoing object is attained by providing a data transfer apparatus for outputting a data group having data represented by plural bits to predetermined processing means, comprising: calculation means for performing logical OR calculation on all the data group to be transferred; and specifying means for specifying a non-zero lowest-order bit position among bits constructing the result of the logical OR calculation by the calculation means, wherein a bit in a position lower than the lowest-order bit position specified by the specifying means is omitted from processing by the predetermined processing means.

Further, the foregoing object is attained by providing a data transfer apparatus for outputting a data group having data represented by plural bits to predetermined processing means, comprising: calculation means for performing logical OR calculation on all the data group to be transferred; and specifying means for specifying a non-zero highest-order bit potion and a non-zero lowest-order bit position among bits constructing the result of the logical OR calculation by the calculation means, wherein a bit in a position lower than the lowest-order bit position and a bit in a position higher than the highest-order bit position specified by the specifying means are omitted from processing by the predetermined processing means.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the schematic construction of a coding apparatus according to a first embodiment of the present invention;

FIG. 2 is an explanatory view of generation of coded data 22 by performing bit plane coding (21) on pixel values of original image 20;

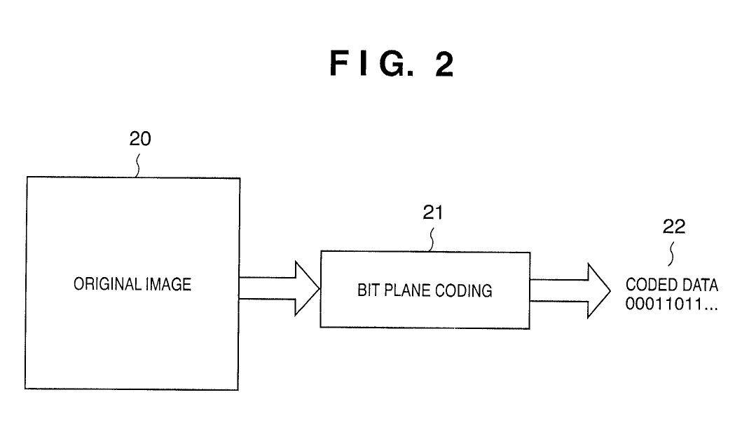

FIG. 3 is an explanatory view of generation of coded data 33 by converting pixel values of original image 30 to coefficient values by transform coding (31) such as DCT or wavelet transform and performing bit plane coding (32) on the coefficient values;

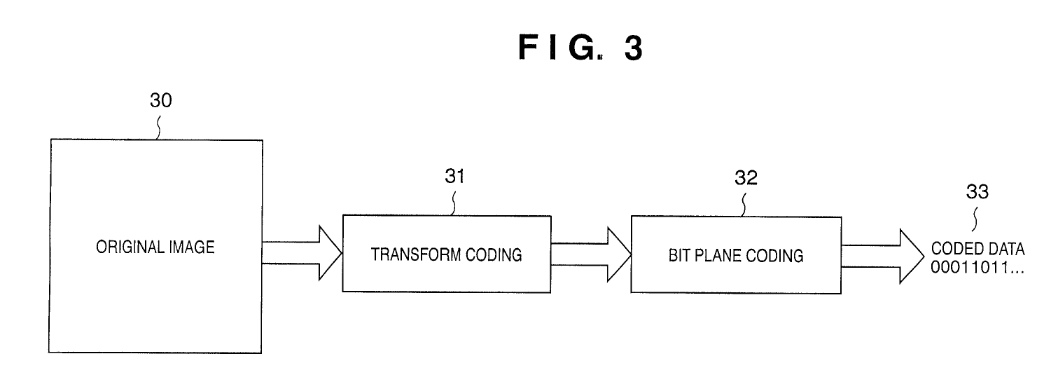

FIG. 4 is an explanatory view of conventional bit plane coding processing;

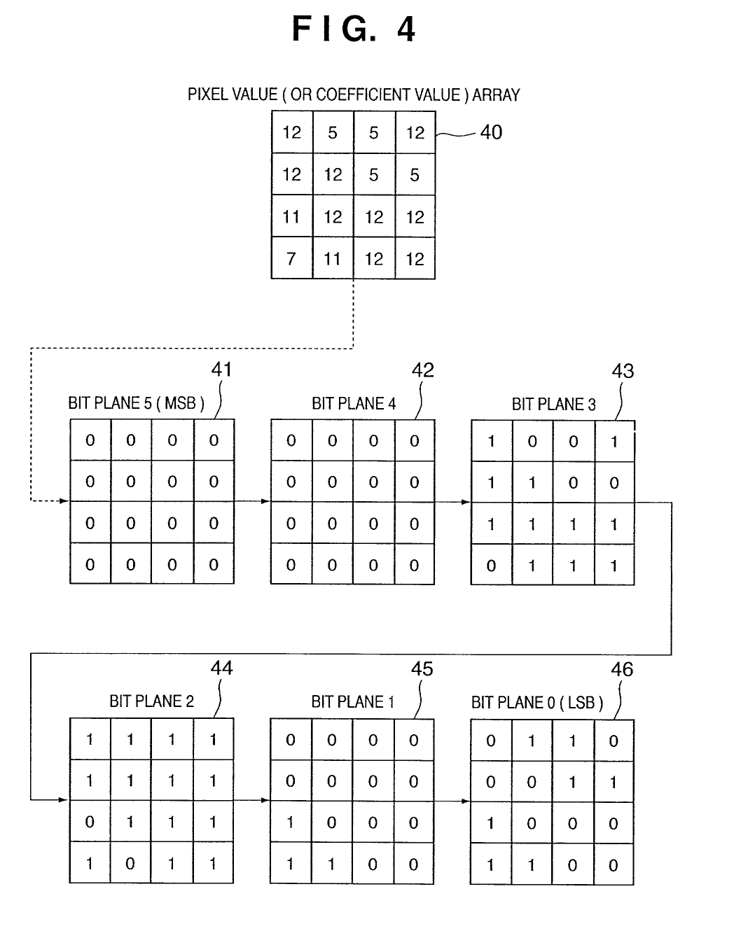

FIG. 5 is an explanatory view of processing to specify a significant bit plane start position;

FIG. 6 is a block diagram showing the construction of a significant bit plane detection circuit 14 according to the first embodiment;

FIG. 7 is a flowchart showing the processing to specify the significant bit plane start position;

FIG. 8 is a block diagram showing the construction of the significant bit plane detection circuit 14 according to a second embodiment of the present invention;

FIG. 9 is an explanatory view of the processing to specify the significant bit plane start position;

FIG. 10 is a flowchart showing processing to detect a lowest-order significant bit plane; and

FIG. 11 is a block diagram showing the construction of the significant bit plane detection circuit 14 according to a third embodiment of the present invention.

### DETAILED DESCRIPTION OF THE PREFERRED EMBODIMENTS

Preferred embodiments of the present invention will now be described in detail in accordance with the accompanying drawings.

[First Embodiment]

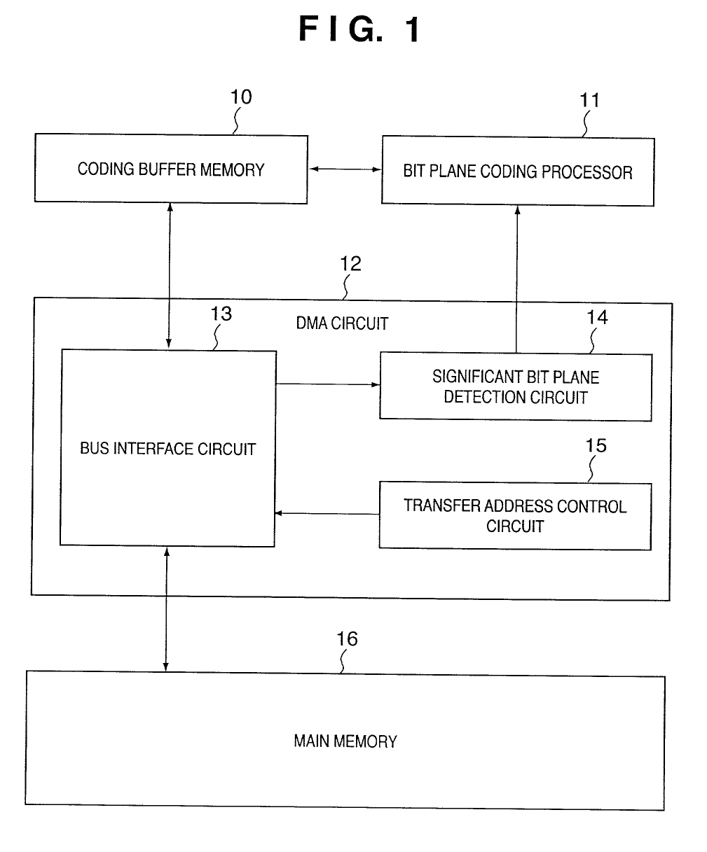

FIG. 1 shows the schematic construction of a coding apparatus including a DMA circuit in a case where a data transfer apparatus according to a first embodiment is applied to the DMA circuit. Hereinbelow, the coding apparatus will be described.

An array of pixel values or coefficient values generated as a result of transform such as wavelet transform upon the pixels is stored on a main memory 16. The stored array is transferred by a DMA circuit 12 to a coding buffer memory 10. Then, a bit plane coding processor 11 (specialized hardware or a CPU) performs bit plane coding on the array, thus generates coded data. Note that the object of processing by the bit plane coding processor 11 may be pixel values or the above-described coefficient values. Hereinafter, the object of processing by the bit plane coding processor 11 will be simply referred to as data (transfer data).

The DMA circuit 12 has a bus interface circuit 13 as an interface between the DMA circuit and a main memory 16, and a transfer address control circuit 15 for data transfer control. In addition, the DMA circuit 12 has a significant bit plane detection circuit 14 which monitors transfer data and detects a highest-order significant bit plane to be described later.

Next, a significant bit plane will be described. A bit plane which includes one or more bits having a non-zero value is called a significant bit plane. Further, in a case where bit planes are examined from a higher-order plane toward a lower-order plane, a bit plane of the highest order among significant bit planes will be referred to as a highest-order significant bit plane. Further, a bit plane where all the bits are 0 will be referred to as an insignificant bit plane.

Upon completion of transfer of data stored in the main memory 16 to the coding buffer memory 10 via the bus interface circuit 13, the bit plane coding processor 11 reads a significant bit plane start position from the significant bit plane detection circuit 14 of the DMA circuit 12. Then the bit plane coding processor 11 performs coding processing only on the significant bit plane(s) where its position is equal to or lower than the significant bit plane start position, while omitting coding processing on higher order insignificant bit plane(s).

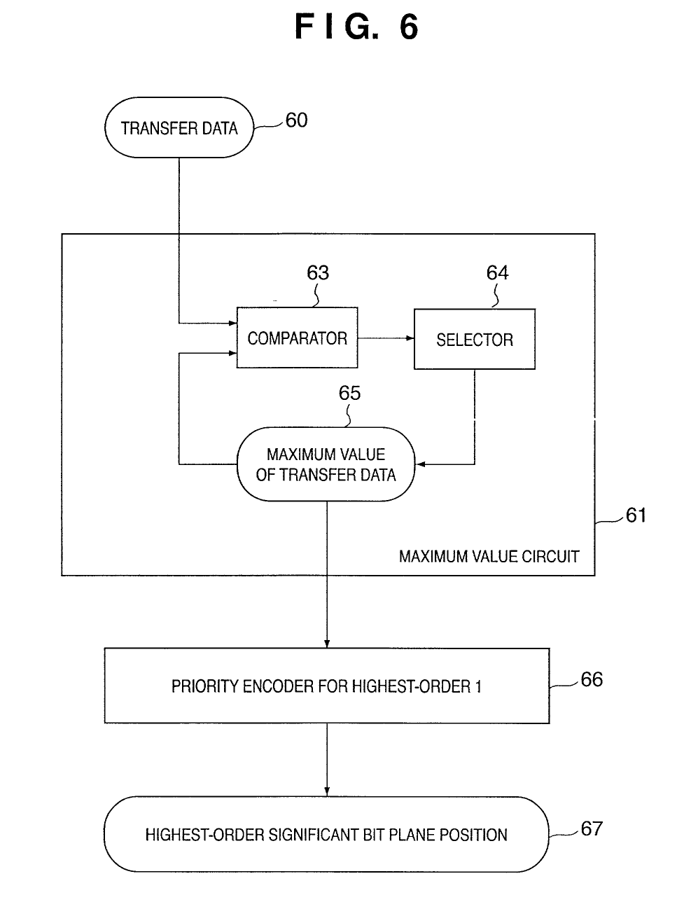

FIG. 6 shows the construction of the significant bit plane detection circuit 14. The significant bit plane detection circuit 14 has a maximum value circuit 61 which monitors data transferred from the main memory 16 via the bus interface circuit 13 to the coding buffer memory 10 and obtains a maximum value of the data, and a priority encoder 66 which encodes the position of highest-order “1” in the binary value of maximum value.

The maximum value circuit 61 compares transfer data 60 with a maximum value of current transfer data 65 (a maximum value of the data transferred to that point) by using a comparator 63, selects a greater value data by using a selector 64, and stores the selected data as a new maximum value into a predetermined memory (not shown). Note that the predetermined memory initially holds a value 0, and initially compared data is always stored as a maximum value in the memory.

This processing is repeated, and when the data transfer from the memory 16 to the coding buffer memory 10 has been completed, a maximum value of the transferred data is stored into the above predetermined memory.

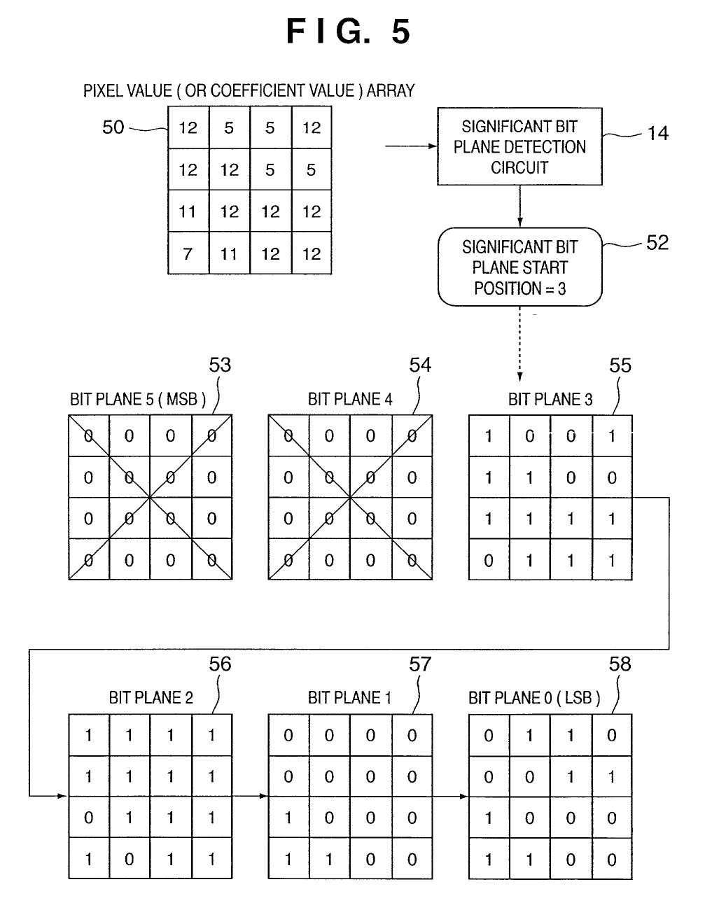

In binary representation of this maximum value, as the position of the highest-order “1” is a significant bit plane start position, the priority encoder 66 encodes this “1” position in binary representation from higher-order, thus specifies the position as described above. Then, the priority encoder 66 outputs a significant bit plane start position 67 (the position of bit plane 3 (55) in FIG. 5).

More particularly, when the above-described transfer data 60 in 8-bit decimal representation has 16 values, 12, 4, 6, 12, 12, 24, 16, 12, 12, 12, 12, 8, 16, 12, 12, and 12, the maximum value circuit 61 detects the maximum value 24 and holds the value. The 8-bit binary representation of the value 24 is 00011000. The priority encoder 66 encodes the position of 1 of the highest order from the highest order position (MSB), i.e., the fourth bit position from the MSB, and outputs the value. In all the transfer data, the bits of higher order than the fourth bit from the MSB are 0, accordingly, the first to third bit planes from the MSB are insignificant bit planes. Accordingly, bit plane coding processing on these insignificant bit planes can be omitted.

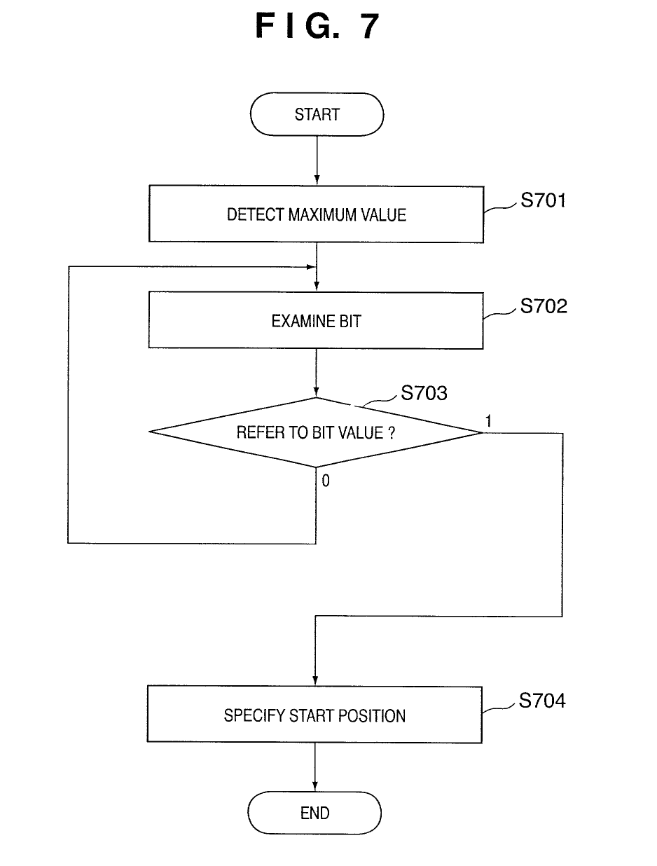

FIG. 7 is a flowchart showing the above processing. Note that program code according to the flowchart is stored in a ROM (not shown) or the like, and read and executed by a CPU or the like to control the significant bit plane detection circuit 14.

At step S701, a maximum value of data is obtained as described above. At step S702, respective bits constructing the maximum value data are examined from the highest order (MSB). At step S703, it is determined whether or not the bit is 1, and if the bit is 1, the process proceeds to step S704, at which the order of the bit from the highest order is specified, and the process ends. On the other hand, if it is determined at step S703 that the bit is 0, the next bit constructing the maximum value is examined.

As described above, the data transfer apparatus and method according to the present embodiment specify bit plane(s) on which coding can be omitted among all the bit planes. As a result, the number of bit planes to be encoded can be reduced, and time required for coding can be reduced.

[Second Embodiment]

In the first embodiment, in the processing to detect insignificant bit plane(s), bit planes are examined from a higher-order bit plane toward a lower-order bit plane, and a highest-order significant bit plane is detected. In a second embodiment, the insignificant bit plane detection processing is performed from a lower-order bit plane toward a higher-order bit plane. Then a lowest-order significant bit plane is specified, and as a result, the number of bit planes to be encoded is reduced.

Note that the construction of the coding apparatus according to the present embodiment is the same as that as shown in FIG. 1. The difference is that the significant bit plane detection circuit 14 of the DMA circuit 12 of the present embodiment monitors transfer data from the memory 16 to the coding buffer memory 10 and detects a lowest-order significant bit plane.

Further, upon completion of transfer of data stored in the main memory 16 to the coding buffer memory 10 via the bus interface 13, the bit plane coding processor 11 according to the present embodiment reads a significant bit plane end position (in the case of coding from a higher-order bit plane) from the significant bit plane detection circuit 14 of the DMA circuit 12. Then, the bit plane coding processor 11 performs coding processing only on the significant bit plane(s) while omitting coding on lower-order insignificant bit plane(s), in accordance with the read value.

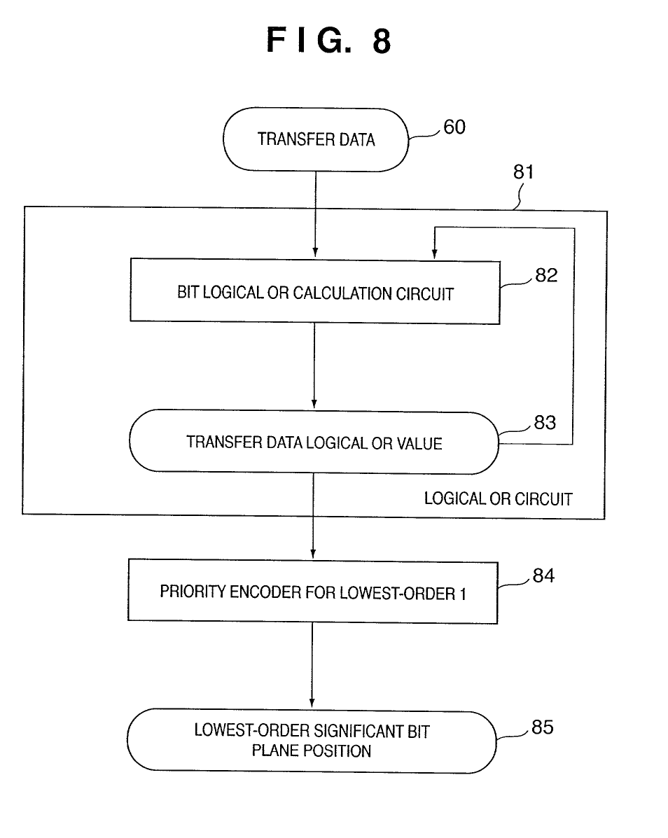

FIG. 8 shows the construction of the significant bit plane detection circuit 14 according to the present embodiment. The significant bit plane detection circuit 14 has a logical OR circuit 81 which monitors data transferred from the main memory 16 to the coding buffer memory 10 via the bus interface circuit 13 and obtains a logical OR value of all the data, and a priority encoder 84 which encodes the position of lowest-order “1” in the result of logical OR of the all the data.

In FIG. 8, the transfer data 60 is inputted into the logical OR circuit 81, and a logical OR of all the transfer data 60 is obtained. The logical OR circuit 81 holds a logical OR value 83 of the transfer data into a predetermined memory (not shown). Then, a bit logical OR calculation circuit 82 calculates a logical OR per bit between the transfer data 60 and the logical OR value 83. Note that the predetermined memory (not shown) initially holds a value 0, and the memory is initialized in advance.

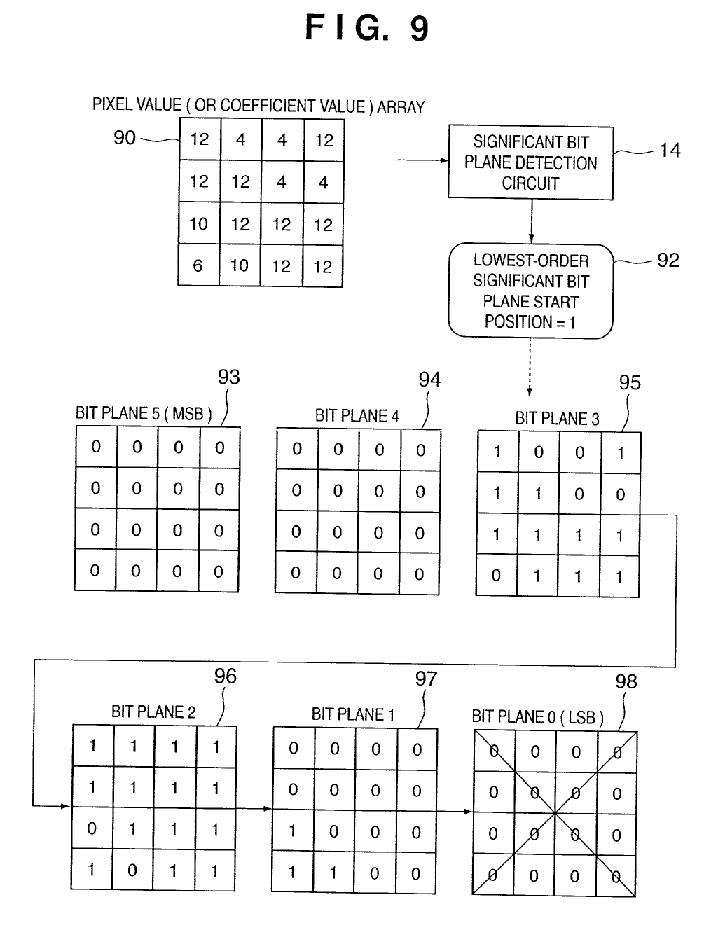

The logical OR value 83 of the transfer data 60 is inputted into the priority encoder 84, which encodes the position of the initial “1” bit from the lowest-order toward a higher-order, and outputs the data. As a result, the output from the priority encoder 84 becomes a lowest-order significant bit plane position 85 (bit plane 1 (97) in FIG. 9).

More particularly, in a case where the transfer data has 16 8-bit decimal values, 12, 4, 6, 12, 12, 24, 16, 12, 12, 12, 12, 8, 16, 12, 12, and 12, the logical OR circuit 81 detects a logical OR value 30 of the entire transfer data, and holds the value in the above-described predetermined memory (not shown). As the decimal numeral 30 is 00011110 in 8-bit binary representation, the priority encoder 84 encodes the position of the lowest-order 1 from the lowest-order bit, i.e., the second bit from the LSB in this case, and outputs the data. As the bit lower than the second bit from the LSB is 0, the first bit plane from LSB is an insignificant bit plane. Accordingly, coding processing on the insignificant bit plane can be omitted.

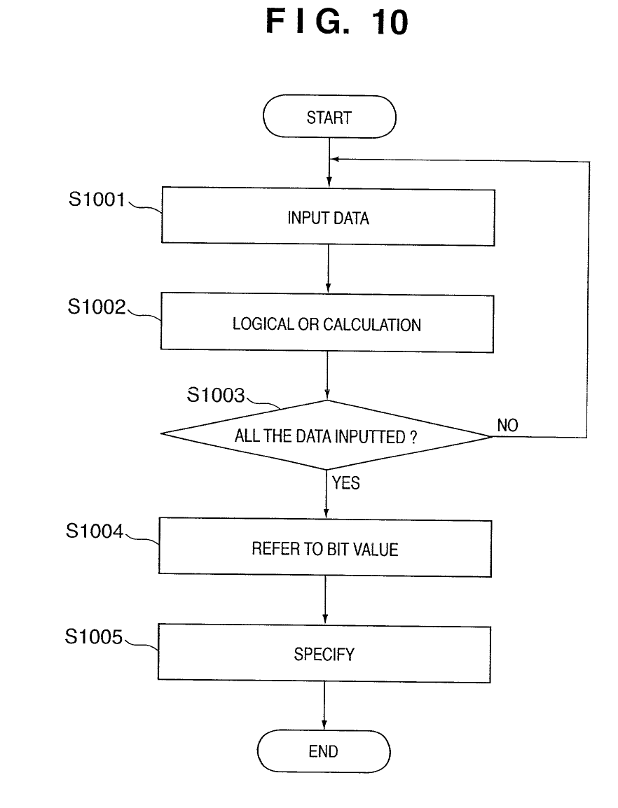

FIG. 10 is a flowchart showing the above processing. Note that program code according to the flowchart is stored in a ROM (not shown) or the like, and read and executed by a CPU or the like to control the significant bit plane detection circuit 14.

At step S1001, the data is referred to, and at step S1002, logical OR calculation is performed. At step S1003, it is determined whether or not the logical OR calculation has been performed on all the data, and if NO, the process returns to step S1001, at which data is inputted and the logical OR calculation is performed again.

If it is determined at step S1003 that the logical OR calculation has been performed on all the data, the process proceeds to step S1004, at which respective bits constructing the value of the result of logical OR are referred to as described above, then at step S1005, the position of the lowest-order significant bit plane is specified.

As described above, the data transfer apparatus and method according to the present embodiment perform processing to detect insignificant bit plane(s) from a lower-order bit plane toward a higher-order bit plane, and specify a lowest-order significant bit plane. As a result, the number of bit planes to be encoded can be reduced as in the case of the first embodiment, and time required for coding can be reduced.

[Third Embodiment]

Further, in a third embodiment, provides data transfer apparatus and method, which further reduce the number of bit planes to be encoded in comparison with the first and second embodiments, by detecting a highest-order significant bit plane and a lowest-order significant bit plane.

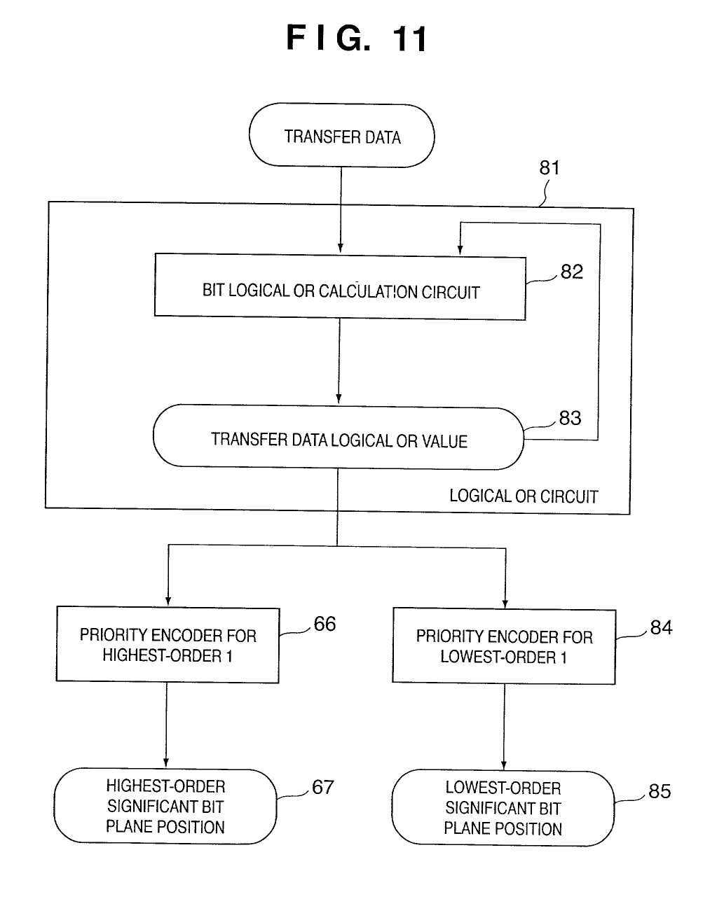

Note that the construction of the coding apparatus according to the present embodiment is the same as that as shown in FIG. 1 except the construction of the significant bit plane detection circuit 14. FIG. 11 shows the construction of the significant bit plane detection circuit 14.

The significant bit plane detection circuit 14 as shown in FIG. 11 has the circuit construction as shown in FIG. 8 connected to the priority encoder 66 used in the first embodiment. That is, the construction to specify the position of lowest-order significant bit plane is the same as that described in the second embodiment.

On the other hand, in the processing to specify the position of highest-order bit plane, the position of highest-order bit plane having a value “1” is specified among bits constructing the logical OR value 83 of the transfer data.

Note that as a flowchart of the processing according to the present embodiment, processing to specify the position of highest-order bit plane having a value “1” among the bits constructing the logical OR value 83 of the transfer data is added to the processing at step S1005 in FIG. 10.

Note that program code according to the flowchart is stored in a ROM (not shown) or the like, and read and executed by a CPU or the like to control the significant bit plane detection circuit 14.

As described above, the data transfer apparatus and method according to the present embodiment specify a highest-order significant bit plane and a lowest-order significant bit plane, thereby further reduce the number of bit planes to be encoded in comparison with the first and second embodiments. As a result, time required for coding can be reduced.

[Other Embodiment]

The present invention can be applied to a system constituted by a plurality of devices (e.g., a host computer, an interface, a reader and a printer) or to an apparatus comprising a single device (e.g., a copy machine or a facsimile apparatus).

According to the above-described embodiments, in bit plane coding, time required for bit plane coding can be reduced by selecting bit plane(s) to be encoded and performing coding only on the selected bit plane(s).

The present invention is not limited to the above embodiments and various changes and modifications can be made within the spirit and scope of the present invention. Therefore, to appraise the public of the scope of the present invention, the following claims are made.

What is claimed is:

1. A data transfer apparatus for outputting a data group having data represented by plural bits to predetermined processing means, comprising:
detection means for detecting a maximum value in the data group as a transfer object; and
specifying means for specifying a non-zero highest-order bit position among bits constructing the maximum value detected by said detection means,
wherein a bit in a position higher than said highest-order bit position specified by said specifying means is omitted from processing by said predetermined processing means.

2. A data transfer apparatus for outputting a data group having data represented by plural bits to predetermined processing means, comprising:
calculation means for performing logical OR calculation on all the data group to be transferred; and
specifying means for specifying a non-zero highest-order bit position among bits constructing the result of the logical OR calculation by said calculation means,
wherein a bit in a position higher than said highest-order bit position specified by said specifying means is omitted from processing by said predetermined processing means.

3. A data transfer apparatus for outputting a data group having data represented by plural bits to predetermined processing means, comprising:
calculation means for performing logical OR calculation on all the data group to be transferred; and
specifying means for specifying a non-zero lowest-order bit position among bits constructing the result of the logical OR calculation by said calculation means,
wherein a bit in a position lower than said lowest-order bit position specified by said specifying means is omitted from processing by said predetermined processing means.

4. A data transfer apparatus for outputting a data group having data represented by plural bits to predetermined processing means, comprising:
calculation means for performing logical OR calculation on all the data group to be transferred; and
specifying means for specifying a non-zero highest-order bit potion and a non-zero lowest-order bit position among bits constructing the result of the logical OR calculation by said calculation means,
wherein a bit in a position lower than said lowest-order bit position and a bit in a position higher than said highest-order bit position specified by said specifying means are omitted from processing by said predetermined processing means.

5. The data transfer apparatus according to claim 1, wherein said predetermined processing means is a coding processor circuit.

6. The data transfer apparatus according to claim 1, wherein said data transfer apparatus includes a DMA circuit.

7. The data transfer apparatus according to claim 1, wherein said data group includes pixel data or transform coefficients generated by transform coding on the pixel data.

8. A data transfer method for outputting a data group having data represented by plural bits to predetermined processing means, comprising:
a detection step of detecting a maximum value in the data group as a transfer object; and
a specifying step of specifying a non-zero highest-order bit position among bits constructing the maximum value detected at said detection step,
wherein a bit in a position higher than said highest-order bit position specified at said specifying step is omitted from processing by said predetermined processing means.

9. A data transfer method for outputting a data group having data represented by plural bits to predetermined processing means, comprising:
a calculation step of performing logical OR calculation on all the data group to be transferred; and
a specifying step of specifying a non-zero highest-order bit position among bits constructing the result of the logical OR calculation at said calculation step,
wherein a bit in a position higher than said highest-order bit position specified at said specifying step is omitted from processing by said predetermined processing means.

10. A data transfer method for outputting a data group having data represented by plural bits to predetermined processing means, comprising:
a calculation step of performing logical OR calculation on all the data group to be transferred; and
a specifying step of specifying a non-zero lowest-order bit position among bits constructing the result of the logical OR calculation at said calculation step,
wherein a bit in a position lower than said lowest-order bit position specified at said specifying step is omitted from processing by said predetermined processing means.

11. A data transfer method for outputting a data group having data represented by plural bits to predetermined processing means, comprising:
a calculation step of performing logical OR calculation on all the data group to be transferred; and
a specifying step of specifying a non-zero highest-order bit potion and a non-zero lowest-order bit position among bits constructing the result of the logical OR calculation at said calculation step,
wherein a bit in a position lower than said lowest-order bit position and a bit in a position higher than said highest-order bit position specified at said specifying step are omitted from processing by said predetermined processing means.

12. The data transfer method according to claim 8, wherein said data transfer method includes a data transfer method in a DMA circuit.
